(19) United States
(12) Patent Application Publication
(10) Pub. No.: US 2012/0266438 A1
(43) Pub. Date: Oct. 25, 2012

(54) LATCH, LATCHING SYSTEMS AND METHODS FOR TEMPORARILY ASSOCIATING OBJECTS USING A MAGNETIC RETENTION FEATURE

(75) Inventors: L. Paul Nickerson, Seattle, WA (US); Philip R. Hitch, Bainbridge Island, WA (US)

(73) Assignee: CASCADE DESIGNS, INC., Seattle, WA (US)

(21) Appl. No.: 13/429,285

(22) Filed: Mar. 23, 2012

Related U.S. Application Data
(63) Continuation of application No. PCT/US2010/002627, filed on Sep. 27, 2010.
(60) Provisional application No. 61/277,500, filed on Sep. 25, 2009.

(51) Int. Cl. F16B 21/00; B23P 11/00

(52) U.S. Cl. 29/428; 403/326

(57) ABSTRACT

Latches, latch arrangements and related methods for temporarily associating two objects, each having one part of a magnetic catch retention arrangement. Latches according to various embodiments of the invention have matable first and second housings wherein the first housing defines a primary recess and the second includes a primary protrusion that is receivable by the primary recess. A biased, displaceable catch of one housing selectively retains the other housing when the two housings are in a mated condition. The magnetic catch retention arrangement becomes functional after sufficient user displacement of the catch; upon sufficient differential movement of the housings, the magnetic catch retention arrangement no longer has sufficient effect to overcome the catch bias. Upon initial re-association of the housing parts, the catch is physically displaced but not sufficiently to permit operative interaction between it and the magnetic catch retention arrangement, thereby allowing the catch to reengage the opposing housing upon complete association.

### BACKGROUND OF THE INVENTION

It is well known that most latches and systems including such latches (“arrangements”) used for associating two objects require the latch to be held in an open or disengaged position in order to ensure separation of the objects held in association by the latch or latch arrangement, due to the latch being biased to a normally closed or engaged position; unintended separation of the objects is contrary to an inherent purpose of a latch or latch arrangement. Often, the operator of the latch must manually maintain the open or disengaged position. In certain use environments such operational requirements are not acceptable, for example, when the operator suffers from an infirmity that materially affects his or her ability to operate the latch or latch arrangement. Thus, many normally closed latches and latch arrangements include a retention feature that functions to “hold open” the latch without additional operator action. In other words, structure is included to counter the bias towards a normally closed state of the latch or latch arrangement. As such, the latch or latch arrangement, once operated into an “open” state, is retained in such state until subsequent user operation.

The prior art is replete with examples of mechanical retention structure for use with latches and/or latch arrangements, including catch/pawl systems such as found in U.S. Pat. No. 7,066,549, for example, and spring biased detent systems. These prior art systems, however, generally include small parts that both increase the cost of manufacturing the latching apparatus/system as well as the complexity of operation, and additionally are susceptible to malfunction due to breakage or jamming (such as from the introduction of foreign material). Operational reliability is of particular importance with respect to physically challenged individuals that may lack the strength, dexterity or resolution abilities to operate the latch and/or latch arrangement as needed.

### SUMMARY OF THE INVENTION

The invention is directed to normally closed or engaged latches, latch arrangements and related methods of operation for temporarily associating two objects, wherein the latches or latch arrangements comprise magnetic retention means for retaining a catch in a desired position, for example an open or disengaged position. In operation, a user manipulates a latch catch to enable the magnetic retention means to overcome an inherent catch closure or engagement bias where after the two objects may be engaged with and/or disengaged from each other without further user interaction with the latch.

Latches according to various embodiments of the invention comprise matable first and second housings wherein a portion of one housing is receivable by a portion of the other housing, and relative movement there between is constrained when the two housings are mated, preferably in at least two directions. One of the housings, which for purposes of this patent is arbitrarily selected as the first housing, defines or comprises by component integration/association a primary recess while the second housing defines or comprises, by component integration/association, a primary protrusion that is receivable by the primary recess. It should be noted that the primary protrusion may be a clearly distinct element or component of the second housing, or may be a portion thereof; it is the functionality of the second housing that assists in defining what constitutes the primary protrusion. A biased, displaceable catch of one housing, which in at least some preferred embodiments is the first housing, functions to selectively retain the other housing when the two housings are in a mated state. Additionally, latches according to various embodiments of the invention comprise magnetic retention means for retaining the catch in a desired position. In many preferred embodiments, the magnetic retention means becomes functional after user operation of the catch into an open or disengaged state, but prior to disassociation of the two housings; upon initial disassociation, the magnetic retention means no longer has sufficient effect on the catch to overcome the catch closure or engagement bias.

In many invention embodiments, the primary recess putatively defined by or associated with the first housing may be characterized as a longitudinal groove, channel or slot (collectively referred to herein as “slot” unless otherwise specified or apparent from the context in which the term is used), which limits movement of any structure disposed therein in at least two directions, i.e., the slot walls. In such embodiments, the primary protrusion putatively defined by or associated with the second housing may be characterized as a pin (as used herein, a “pin” is a protrusion in a first direction (first axis) wherein the functional dimensions thereof in each of the remaining orthogonal axes are generally similar, e.g., the structure includes generally similar major and minor axes such as found in circular cylinders or square prisms), or as a tongue or land (as used herein, the term “tongue” collectively refers to any protrusion in a first direction (first axis) wherein the functional dimensions thereof in each of the remaining orthogonal axes are not generally similar, e.g., the structure includes unique major and minor axes such as found in elliptical prisms and rectangular prisms). If the slot is further defined by or comprises a web portion (as would characterize a groove or channel), then movement of any structure disposed therein is limited in at least three directions. The slot may further limit movement of any pin or tongue disposed therein by including one or two flange portions extending toward an opposing wall that defines the slot; when the pin or tongue also includes a geometrically enlarged head (such as a “T” or “J” head, in cross section), relative movement in the axis congruent with the normal to the web portion is constrained.

In addition to first and second housings, invention embodiments further comprise the aforementioned displaceable catch, which is biased to an engaged or closed state by a bias means such as a spring or viscoelastic material. This state is considered a nominal state, not dependent upon the presence of a mating association between the two housing, but can be (and is) modified by user operation of the catch and/or functional interaction with the magnetic retention means.

The displaceable catch comprises a latching portion and an actuating portion accessible to a user, and further comprises a mounting interface to facilitate linkage with a housing. Depending upon the use environment, various invention embodiments may include two catches or functional equivalents, e.g., one for each housing. With the foregoing caveats in mind, the displaceable catch latching portion of many invention embodiments is configured to selectively/removeably engage with a portion of the mated housing (generally referred to as an anchor portion). The catch actuating portion preferably comprises means for enabling convenient user operation of the catch.

The structure, configuration and relative spatial positioning of the catch latching portion and the anchor portion is such that when the catch is in the closed or engaged position and the two housings are in mated association, disassociation of the two housings is not reasonably possible without user operation of the catch actuating portion. Because the means by which this temporary mating association is accomplished is secondary to the objective of retaining (and releasing) the mating association, various invention embodiments may comprise distinct structural arrangements that are nevertheless functional equivalents of the catch.

The catch further comprises one part of the magnetic retention means (another part of the magnetic retention means is found in at least one of the housings). For design and cost optimization, the catch preferably comprises a target portion that is passively responsive to a magnetic field, e.g., ferrous metals, although various invention embodiments are fully enabled where the target portion comprises magnetic properties either intrinsic or induced. The target portion of the catch is located and configured both with respect to the catch and to the housing in which the catch is disposed to selectively interact with a magnetic field producing element (magnetic means), which is preferably associated with the housing not comprising the catch, although various invention embodiments are fully enabled where the magnetic means is present in combination with the same housing. The location of the target portion is such that an attraction or repulsion bias resulting from its interaction with the magnetic means is sufficient to overcome the closure or engagement bias presented to the catch when at least one of a range of spatial relationships between the target portion and the magnetic means has been achieved, such as after successful user operation of the catch actuating portion to position the catch into an open or disengaged state.

As previously described, a purpose of the magnetic retention means is to retain the catch in an open or disengaged state, thus enabling a user to separate or disassociate the two housings without continued effort to overcome the catch bias means. Various invention embodiments further provide means for indirectly overcoming the magnetic retention means so that the catch once again returns its nominal, closed or engaged state. This feature finds particular utility when the two housings are being brought into mating association—the user need not operate the catch to overcome the bias established by the magnetic retention means so that the catch returns to its nominal state when the two housings are matingly associated. These catch return means include structure, preferably defined by or associated with the housing not comprising the catch, which minimizes the flux density of the magnetic field and/or presents sufficient force to the catch so as to overcome the bias established by the magnetic retention means. Examples of the first instance include mechanical displacement of the magnetic means that is not part of the catch or interposition of a ferrous structure between such magnetic means and the catch; examples of the second instance include a ramp or similar catch displacing structure associated with the housing not comprising the catch.

Many invention embodiments are constructed to disengage the magnetic retention means (disassociate the at least two components making up the magnetic retention means) such that the catch returns to its nominal state once the two housings are separated. This functionality is possible since the functionality of the magnetic retention means is only necessary to enable disassociation of the two housings; once separated, the state of the catch is no longer material until mating association is desired (see below for features directed to such conditions). One means by which such functionality can be achieved comprises the location/integration of one part of the magnetic means on the housing not comprising the catch. As this housing, which is preferably the housing comprising the primary protrusion, is separated from the other housing, the spatial distance between another part of the magnetic means such as the target portion increases, eventually to the point where the catch bias exceeds the magnetic retention means bias, where after the catch returns to its nominal state.

A related feature of many invention embodiments relates to the ability of the housings, during the mating association operation, to momentarily overcome the closure or engagement bias of the catch and cause the catch to displace from its nominal position (recall that the catch nominal state is the closed/engaged position). In so doing, a user is able to fully mate the two housings without direct operation of the catch. Once mated, subsequent closure/engagement of the catch latch portion with the anchor portion is achieved due to the catch closure/engagement bias, as previously described, which is no longer overcome. Such functionality removes the requirement of a user to otherwise “reset” the catch into an open or disengaged position during this mating association operation; the user need only associate the two housings, which is highly desirable for mobility challenged users. In one series of embodiments, introduction of one housing portion, preferably the primary protrusion if the catch presents to the primary recess of the other housing, physically displaces the catch from its nominal position until the two housings are substantially mated, where after such displacement ceases. Examples of such structure include tongues having ramped or contoured surfaces adjacent to the anchor portion, or similar structure that function as a cam where the catch comprises a cam follower portion.

Depending upon the embodiment, one or both housings may further comprise at least one object mounting interface, which may include means for accommodating various dimensioned objects and/or means for adjusting the position of the housing relative to the object to which it is mounted. In addition to housing insertion assistance means such as enlarging a portion of the primary recess to facilitate off-axis insertion of the primary protrusion such as in the case of a slot having a throat for receiving a tongue, the mounting interface(s) and/or associated fasteners can be constructed from ferrous metals and intelligently positioned to assist in locating a tongue having one part of the magnetic means, such as a permanent magnet.

In view of the foregoing, latching arrangements according to certain preferred embodiments of the invention, when the housings are matingly associated with each other and when the catch has been manipulated into a disengaged or open position, retain the catch in the such position until the two housings are at least partially disassociated, where after the catch is biased to return to its nominal position, regardless of the presence of the second housing. This functionality has the advantage of returning the activating portion of the catch to its “locked” or engaged position, which in the prior art is usually a stowed or protected position. Thus, the activating portion is not unnecessarily exposed during the period of separation between the two housings. Depending upon the embodiment, when association of the two housings is desired, the catch can then be passively or indirectly manipulated into the disengaged or open position, such as by the simply act of associating the two housings, or the catch can be actively or directly manipulated into the disengaged or open position, such as by manipulation of the catch activating portion. Again depending upon embodiments of the invention, once the two housings are associated, the catch can be passively or indirectly manipulated into the engaged or closed position, such as by the bias provided by a spring or gravity, or the catch can be actively or directly manipulated into the engaged or closed position such as by manipulation of the catch activating portion. At this point, the latch portion of the catch has engaged the anchor portion of the mating housing, and unintentional separation of the housings is therefore prevented.

Use of magnetic retention means in a latch or latch arrangement to temporarily retain a catch in an open or disengaged position greatly simplifies both construction and operation, and further avoids most malfunctions due to component wear, breakage or jamming. Additionally, intelligent designing of the housings may also permit bilateral usage of the same parts. In other words, by making the housings functionally symmetrical, the housings may be used in both “left hand” and “right hand” positions.

Embodiments of the invention will find particular utility with respect to removable seatbacks in the wheelchair arts. Many wheelchairs, such as those used for sports or when torso positioning is desired, have hard shell seatbacks. Such seatbacks, however, are not conducive to stowage of the wheel chairs, such as for transport purposes. Consequently, the ability to quickly remove and install these seatbacks is considered an important usability factor. Through the incorporation of embodiments of the invention, a user need only release the catches in order to be able to remove the seatback; the catches remain in the disengaged or open position until the seatback has successfully disengaged from the housing comprising the catch. Once removed, a preferable spring bias causes the catches to return to their normally engaged or closed position. To facilitate easy re-engagement of the seatback, the latch arrangements include passive means to temporarily cause the catches to move to the disengaged or open position when the seatback is replaced prior to again returning to the engaged or closed position once the seatback is in its home position.

For purposes of this patent, the terms “area”, “boundary”, “part”, “portion”, “surface”, “zone”, and their synonyms, equivalents and plural forms, as may be used herein and by way of example, are intended to provide descriptive references or landmarks with respect to the article and/or process being described. These and similar or equivalent terms are not intended, nor should be inferred, to delimit or define per se elements of the referenced article and/or process, unless specifically stated as such or facially clear from the several drawings and/or the context in which the term(s) is/are used.

### BRIEF DESCRIPTION OF THE DRAWINGS

FIG. 1 is a perspective view of a latch arrangement according to an embodiment of the invention shown mounted to a wheel chair cane and seatback during an insertion operation of a bar comprising a modified T track head into a receiver housing defining a T slot;

FIG. 2 is a perspective view of the arrangement of FIG. 1 after completion of the insertion operation

FIGS. 3a-f are respective perspective, front, side and rear elevation views as well as top and bottom plan views of the receiver housing of FIG. 1 illustrating a primary recess in the form of a slot having an enlarged throat on a front side thereof and a secondary recess for receiving a catch and spring on a rear side thereof in addition to a recessed mounting interface;

FIGS. 4a and 4b are respective perspective and side elevation views of a catch receivable in the receiver housing of FIG. 1 illustrating a latching portion, user activating portion and mounting portion as well as a target portion for engaging with a magnet;

FIGS. 5a-e are respective perspective, front, side and rear elevation views as well as a top plan view of the bar of FIG. 1 illustrating the modified T track head with anchor portion detents for receiving the latching portion of the catch and recessed magnet in addition to a mounting interface; and

FIGS. 6a-d are a series of cross section views of the arrangement of FIG. 1 wherein showing the bar releasing from the receiver housing after user operation of the activating portion of the catch and subsequent reinsertion of the bar wherein the catch is passively urged to an open/disengaged position

### DESCRIPTION OF INVENTION EMBODIMENTS

Preface: The terminal end of any numeric lead line in the several drawings, when associated with any structure or process, reference or landmark described in this section, is intended to representatively identify and associate such structure or process, reference or landmark with respect to the written description of such object or process. It is not intended, nor should be inferred, to delimit or define per se boundaries of the referenced object or process, unless specifically stated as such or facially clear from the drawings and the context in which the term(s) is/are used. Unless specifically stated as such or facially clear from the several drawings and the context in which the term(s) is/are used, all words and visual aids should be given their common commercial and/or scientific meaning consistent with the context of the disclosure herein.

With the foregoing in mind, the following description is presented to enable a person skilled in the art to make and use the claimed invention. Various modifications to the described embodiments will be readily apparent to those skilled in the art, and the generic principles disclosed herein may be applied to other embodiments and applications thereof without departing from the spirit and scope of the present invention, as defined by the appended claims. Thus, the claimed invention is not intended to nor should be limited to the disclosed and/or described embodiments, but is to be accorded the widest scope consistent with the principles and features disclosed herein.

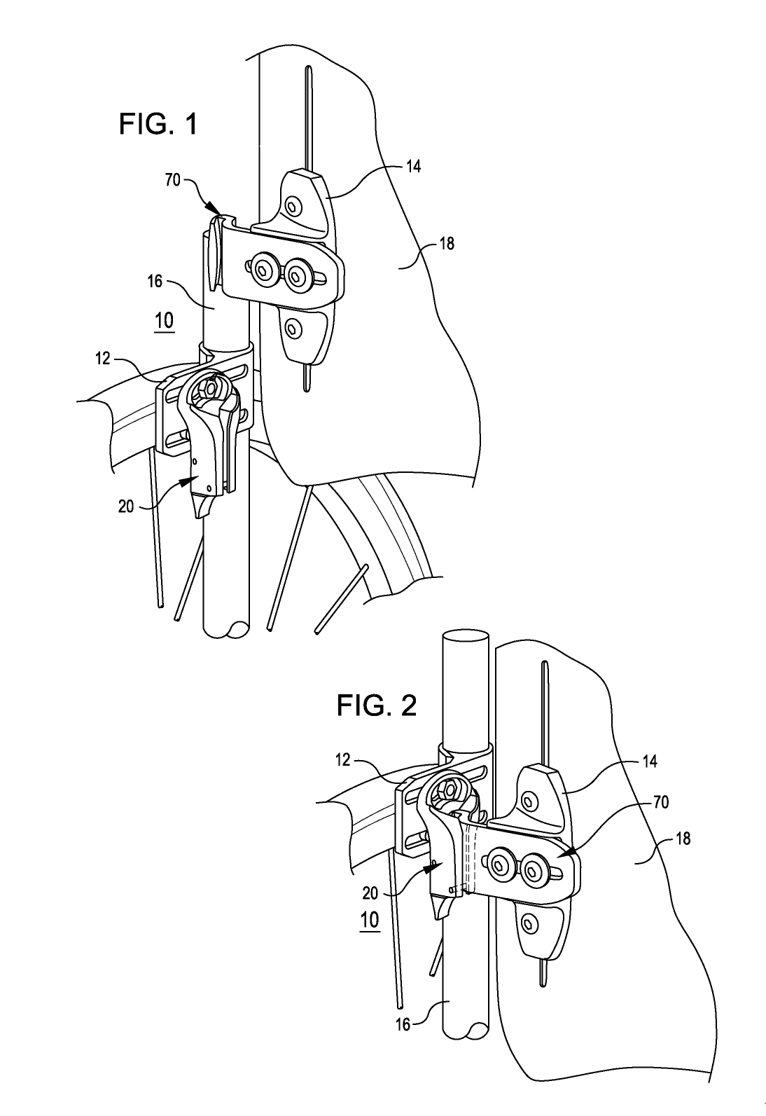

Turning then to the several embodiments, wherein like numerals indicate like parts the components and operation of an invention embodiment will be described. Referring first to FIGS. 1, 2 and 7, latch 10 includes housing 20 and bar 70. Housing 20 and bar 70 are shown mounted to respective adjustable mounting interfaces 12 and 14, which are in turn adjustably attached to wheelchair cane 16 and seatback 18 via conventional fasteners. Both housing 20 and bar 70 are preferably constructed from aluminum or polymeric material, but can be constructed from any preferably non-ferrous metal or material to minimize collateral effects on the magnetic retention means discussed below.

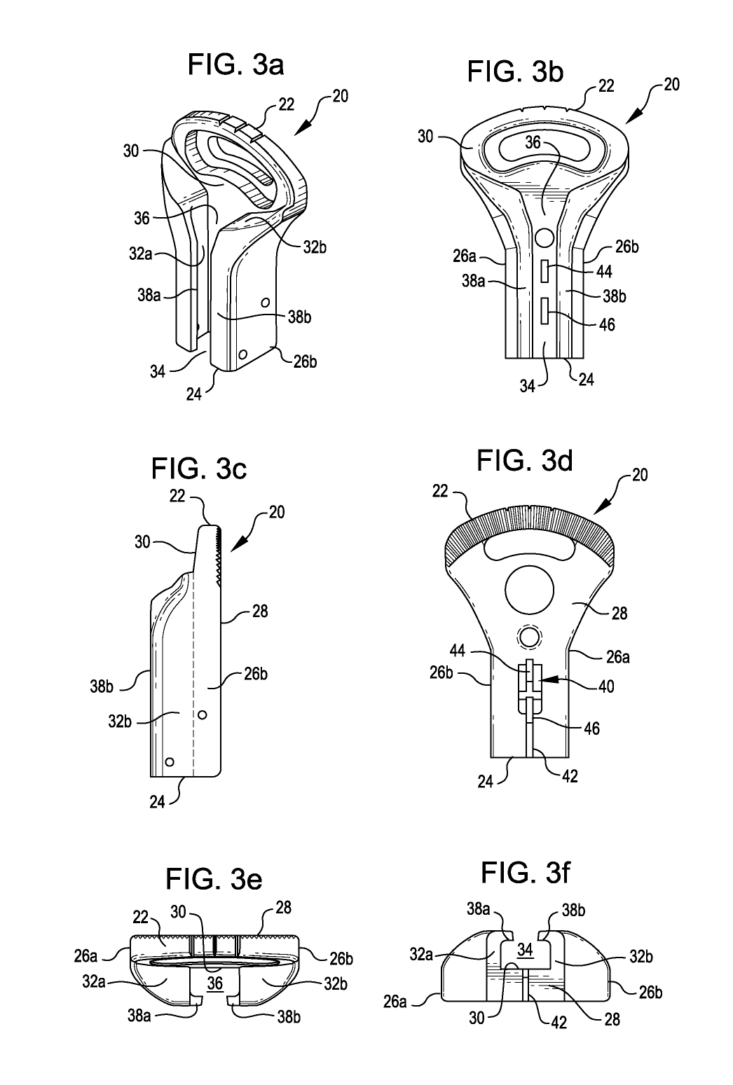

Housing 20 is best shown in FIGS. 3a-f, and includes upper portion 22, lower portion 24, sides 26a and 26b, back side 28 and front side 30. Extending from front side 30 are walls 32a and 32b that define “T” slot or channel 34, and which flare to form throat 36. Extending adductively from walls 32a/b are flange portions 38a and 38b. Sides 26a/b define receiving holes for a pivot pin while walls 32a/b define receiving holes for a stop pin. Formed in back side 28 is recess 40, which is sized to a receive torsion spring (not shown for clarity), as well as slot 42 and mortises 44 and 46, which are sized to receive portions of the catch discussed below.

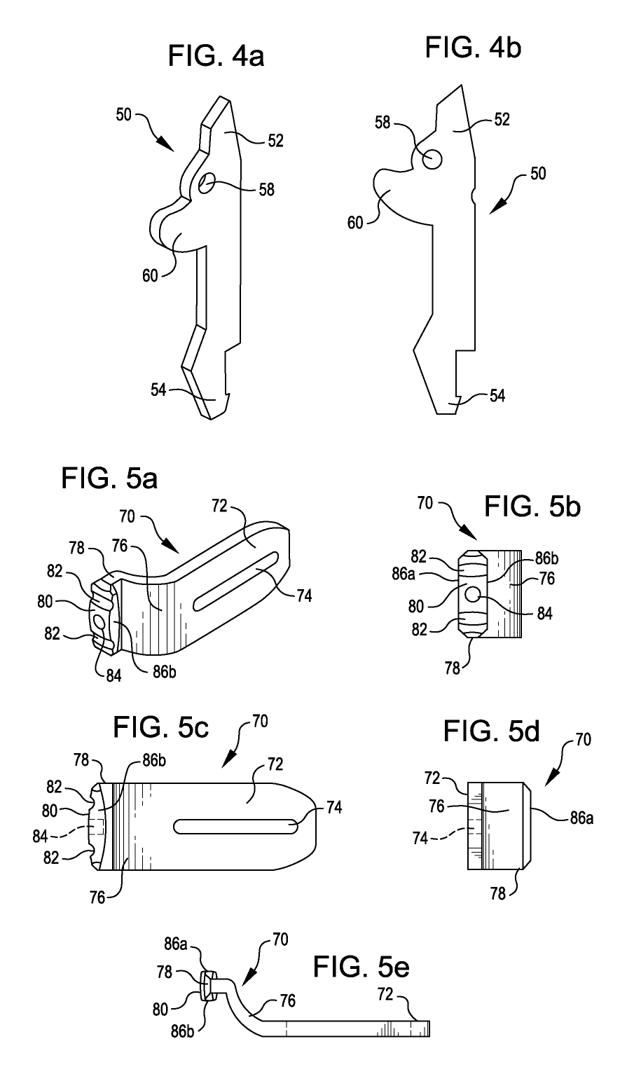

Turning then to FIGS. 4a and 4b, catch 50 is shown having upper portion 52, which functions as a target portion, lower portion 54, which functions as an activating portion, and body portion 56, which includes pivot hole 58 and latching portion 60. Catch 50 is primarily disposed in recesses 40 and 42 of housing 20, where upper portion 52 and latching portion 60 reciprocally occupy mortises 44 and 46 discussed in more detail below. As noted previously, at least upper portion 52 is responsive to magnetic fields.

Finally, FIGS. 5a-e show the various parts to bar 70. As shown therein, bar 70 includes mounting portion 72, which define mounting slot 74, offset portion 76, which functions as a transition between mounting portion 72 and “T” track portion 78. “T” track portion 78 includes face 80, which defines lateral anchor detents or grooves 82 as well as recess 84 for receiving a button magnet (not shown). Sides 86a/b of “T” track portion 78 have a slight rocker to facilitate insertion and removal of the track portion from “T” slot or channel 34 of housing 20.

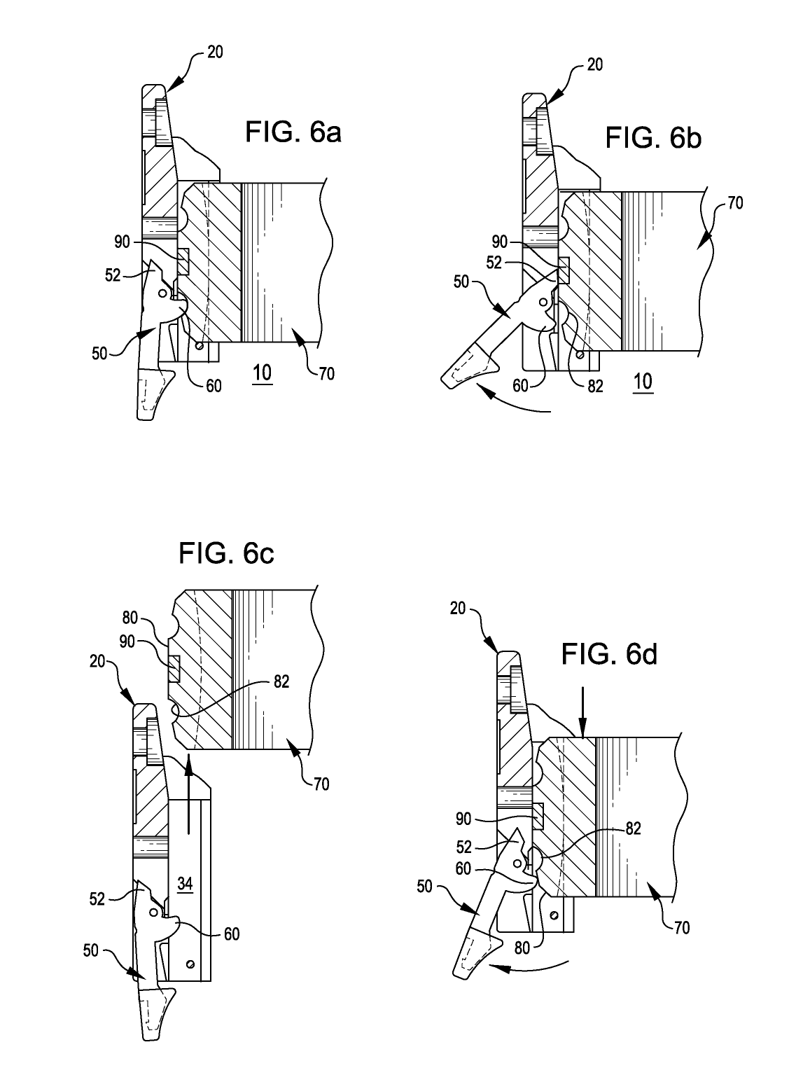

FIGS. 6a-d illustrate bar 70 releasing from housing 20 through operation of catch 50 where catch 50 is rotated as shown by the arrow in FIG. 6b, thereby disengaging latching portion 60 from groove 82 and engaging upper portion 52 of catch 50 with magnet 90. This attractive bias functions to retain catch 50 in the illustrated position as long as magnet 90 remains proximate to upper portion 52. However, when bar 70 is removed from housing 20 as shown in FIG. 6c, the catch bias is no longer opposed by the attractive bias of magnet 90 acting on upper portion 52, and catch 50 returns to its nominal position. However, when bar 70 is reintroduced into slot 34, face 80 impinges upon latching portion 60, which causes catch 50 to rotate and accept bar 70.

1. A two part latch comprising:
a first housing defining a primary recess and comprising a displaceable, catch having a latching portion, an activating portion and a target portion wherein the catch is biased towards a normally closed or engaged state;
a second housing comprising a protrusion receivable by the primary recess of the first housing and an anchor portion for engaging with the catch latching portion; and
magnetic means for establishing a bias in at least partial opposition to the catch bias when the second housing is proximate to the first housing.

2. The two part latch of claim 1, whereby the the magnetic means bias is sufficient to overcome the catch bias when the catch is positioned into an open or non-engaged state.

3. The two part latch of claim 2, whereby the catch is positioned into an open or non-engaged state through user manipulation of the catch activating portion.

4. The two part latch of claim 2, whereby the catch target portion comprises a first part of the magnetic means and is adjacent to a second part of the magnetic means that is part of the protrusion when the catch is positioned into an open or non-engaged state.

5. The two part latch of claim 3, whereby the catch target portion is in contact with the second housing when the catch is positioned into an open or non-engaged state.

6. The two part latch of claim 1, wherein the catch bias predominantly comprises the force of gravity.

7. The two part latch of claim 2, whereby the the magnetic means bias is insufficient to overcome the catch bias when the second housing is not positioned proximate to the first housing.

8. The two part latch of claim 1, wherein the catch is pivotally mounted to the first housing.

9. The two part latch of claim 1, wherein the first housing is generally symmetrical about a first plane.

10. The two part latch of claim 1, wherein the protrusion is bidirectionally receivable by the primary recess of the first housing.

11. The two part latch of claim 1, further comprising means for receiving the protrusion during association of the two housings when the catch is in the normally closed or engaged state.

12. The two part latch of claim 11, wherein the means for receiving the protrusion during association of the two housings comprises a transition proximate to the anchor portion of the protrusion whereby the transition portion initially contacts the catch during insertion of the protrusion into the recess and prior to engagement of the catch latching portion with the protrusion anchor portion.

13. The two part latch of claim 11, whereby the catch is caused to pivot.

14. The two part latch of claim 4, wherein the catch target portion is in contact with the protrusion when the catch is positioned into an open or non-engaged state.

15. The two part latch of claim 14, wherein the protrusion comprises a permanent magnet and the catch target portion is formed from a ferrous material.

16. A method for operating a two part latch comprising:
introducing a protrusion extending from a first housing into a primary recess defined by a second housing;
allowing a latching portion of a displaceable catch, which is disposed in the second housing and has an activating portion and a target portion, to engage with an anchor portion defined by the protrusion of the first housing, wherein the catch has a bias towards a normally closed or engaged state;
operating the activating portion of the catch to allow magnetic retention means between the catch target portion and the second housing protrusion, thereby establishing a bias sufficient to overcome the catch bias and retain the catch in an open or non-engaged state; and
removing the protrusion from the primary recess.
